(19) United States
(12) Patent Application Publication
(10) Pub. No.: US 2023/0137899 A1
(43) Pub. Date: May 4, 2023

(54) REMOVABLE SOLAR ROOF ASSEMBLY

(71) Applicant: Super ATV, LLC, Madison, IN (US)

(72) Inventor: Chris Shelton, Madison, IN (US)

(21) Appl. No.: 17/452,843

(22) Filed: Oct. 29, 2021

(51) Int. Cl. H02S 20/30; H02S 10/40

(52) U.S. Cl. CPC H02S 20/30; H02S 10/40

(57) ABSTRACT

A removable roof for an off-road vehicle includes a sheet of polycarbonate and one or more solar energy collection elements attached to the sheet of polycarbonate. Electrical connections adapted to allow energy collected by the solar energy collection elements to flow to an electrical power output are also provided. The solar energy collection elements may be attached to the top and/or bottom surface of the sheet of polycarbonate, or they may be encapsulated in the sheet of polycarbonate. The roof may be removably attachable to the cage of an off-road vehicle using fasteners that may be installed or removed using only common hand tools.

### FIELD OF THE INVENTION

The present invention relates generally to off-road vehicles, and more particularly to accessories for off-road vehicles such as all-terrain (ATV) vehicles and utility task (UTV) vehicles.

### BACKGROUND TO THE INVENTION

Off road vehicles typically have a cage to protect the occupants from injury if the event of a rollover. In some cases, the cage may support accessories such as a removable roof to provide shelter from the elements when desired.

Solar energy collection panels are used to collect solar energy and convert it to electrical power that can be used to power any electrical device.

A need exists for a solar roof assembly that can be adapted to the harsh environment of off-road vehicle use. The present invention address that need.

### SUMMARY OF THE INVENTION

In one preferred aspect of the present invention there is provided a removable vehicle roof, preferably comprising a sheet of clear polycarbonate, and one or more solar energy collection panels or elements attached to the sheet of material. Electrical connections adapted to allow energy collected by the solar energy collection panel/elements to flow to an electrical power output may also be provided.

In some embodiments the solar collection panels/elements are attached to the top surface of the sheet of polycarbonate, while in other embodiments the solar collection panels/elements are attached to the bottom surface of the sheet of polycarbonate. In other embodiments the solar collection elements are encapsulated within the sheet of polycarbonate or other material.

In some embodiments the solar collection elements are fixedly attached to the sheet of material, while in other embodiments the solar collection elements are removably attached to the material. The fixedly or removably attached solar energy collection elements may be attached directly or indirectly to the surface of the sheet of material.

The vehicle roof may be removably attachable to a vehicle. For example, a vehicle roof assembly may comprise: a) a roll-over protection system cage mounted to a vehicle body, the cage comprising a pair of A-pillar members, a pair of B-pillar members, a first cross member connected the two A-pillar members, a second cross member connected the two B-pillar members, a first longitudinal member connecting one of the A-pillar members to the corresponding B-pillar member, and a second longitudinal member connecting the other of the A-pillar members to the other of the B-pillar members; and

b) a vehicle roof removably mountable to the roll-over protection system cage, wherein the roof comprises:
i) a sheet of clear polycarbonate, having a top surface and a bottom surface;
ii) one or more solar energy collection elements fixedly attached to the sheet of polycarbonate; and
iii) an electrical connection adapted to allow energy collected by the solar energy collection elements to flow to an electrical power output.

The elements of the removable solar roof may be provided as a kit. For example, such a kit may comprise:
a) a removable solar roof elements comprising a sheet of clear polycarbonate and having a top surface and a bottom surface;
b) one or more solar energy collection elements fixedly attached to the solid roof surface;
c) an electrical connection to allow electrical energy collected by the solar energy collection elements to flow to a solar power output; and
d) one or more fasteners for removably attaching the roof to a roll-over protection system cage of the vehicle.

Further, the plurality of fasteners may comprise clamps adapted to fasten the roof assembly to the cage of an off-road vehicle.

### DESCRIPTION OF THE DRAWINGS

FIGS. 1-29 show various embodiments and features of the removable solar energy collection roof of the present invention.

FIG. 1 shows a top perspective view of one embodiment of the present invention.

FIG. 2 shows a top plan view of one embodiment of the present invention.

FIG. 3 shows another top perspective view of the embodiment of FIG. 2.

FIG. 4 shows a bottom plan view of the embodiment of FIG. 2.

FIG. 5 shows a side elevational view of the embodiment of FIG. 2.

FIG. 6 shows a side elevational view of another embodiment of the present invention.

FIG. 7 shows an opposite side elevational view of the embodiment of FIG. 6.

FIG. 8 shows a front elevational view of the embodiment of FIG. 2.

FIG. 9 shows a rear elevational view of the embodiment of FIG. 2.

FIG. 10 shows another top perspective view of the embodiment of FIG. 1.

FIG. 11 shows another top perspective view of the embodiment of FIG. 10.

FIG. 12 shows a side perspective view of the embodiment of FIG. 10.

FIG. 13 shows another top perspective view of the embodiment of FIG. 10.

FIG. 14 shows another top perspective view of the embodiment of FIG. 10.

FIG. 15 shows another top perspective view of the embodiment of FIG. 10.

FIG. 16 shows another top plan view the embodiment of FIG. 10.

FIG. 17 shows another side elevational view of the embodiment of FIG. 10.

FIG. 18 shows another front elevational view of the embodiment of FIG. 10.

FIG. 19 shows another top perspective view of the embodiment of FIG. 10.

FIG. 20 shows another bottom plan view of the embodiment of FIG. 10.

FIG. 21 shows another top plan view of the embodiment of FIG. 10.

FIG. 22 shows another top perspective view of the embodiment of FIG. 10.

FIG. 23 shows another top perspective view of the embodiment of FIG. 10.

FIG. 24 shows a bottom perspective view of one embodiment of the present invention, in which the array of solar energy collection elements are supported on bottom surface of the polycarbonate sheet.

FIG. 25 shows a bottom perspective view of the embodiment of FIG. 24.

FIG. 26 shows another front perspective view of the embodiment of FIG. 24.

FIG. 27 shows another bottom plan view of the embodiment of FIG. 24.

FIG. 28 shows another side elevational view of one embodiment of the present invention.

FIG. 29 shows another perspective view of one embodiment of the present invention.

FIG. 30 shows a vehicle with a roll-over protection cage before installation of the removable solar energy collection roof of the present invention.

FIG. 30 shows a vehicle with a roll-over protection system mounted thereon.

FIG. 31 shows cage surfaces for accepting bolts or other fasteners to mount the roof to the cage.

FIG. 32 shows clamps that may be used to attach the inventive roof to the vehicle.

FIG. 33 shows clamps attached to the polycarbonate sheet portion of the roof.

FIG. 34 shows an off-road vehicle with the polycarbonate sheet portion of the roof removably attached to a vehicle.

### WRITTEN DESCRIPTION

For the purposes of promoting an understanding of the principles of the invention, reference will now be made to certain embodiments and specific language will be used to describe the same. It will nevertheless be understood that no limitation of the scope of the invention is thereby intended, such alterations and further modifications in the described device, and such further applications of the principles of the invention as illustrated therein, being contemplated as would normally occur to one skilled in the art to which the invention relates.

As indicated above, one aspect of the present invention relates to a vehicle roof, comprising a sheet of material, and preferably a sheet of clear polycarbonate, having a top surface and a bottom surface, and one or more solar energy collection elements attached to the sheet of material. An electrical connection adapted to allow energy collected by the solar energy collection elements to flow to an electrical power output is also preferably provided.

The sheet of material is preferably polycarbonate, and more preferably a sheet of clear polycarbonate. Alternatively, the sheet may be tinted polycarbonate, or it may be another plastic, such as acrylic, ABS, PET, acetal, HDPE, or UHMW, or it may be another material entirely, such as sheet aluminum or steel. For the purposes of this disclosure, the invention will be descripted as utilizing sheets of polycarbonate, but other materials are intended to be within the scope of the disclosed invention.

The solar energy collection elements used in the present invention may be panels, or cells, or another solar energy collection form factor, as is known to the art. One or more solar energy collection elements may be combined and connected together to form one larger panel, or they may be provided as distinct elements. In addition, the solar energy collection elements may comprise one or more monocrystalline, polycrystalline, or thin-film solar panels or cells.

The solar energy collection elements may be attached to the top surface of the sheet of polycarbonate, or they may be attached to the bottom surface. Similarly, the solar energy collection elements may be fixedly or removably attached to the sheet of polycarbonate.

In another embodiment an array of solar energy collection elements or cells is encapsulated in the sheet of polycarbonate. This provides superior protection for the cells, and also reduces drag. When the solar energy collection elements are encapsulated in the sheet of polycarbonate, there is a layer of polycarbonate above the solar energy collection elements, and a layer of polycarbonate below the solar energy collection elements.

In some embodiments the roof is quickly installed and quickly removed from the vehicle. This may be done by attaching the roof to the vehicle with clamps or clips, which may be quick-release clamps or clips. In certain preferred embodiments the roof is attached to a roll-over protection system/cage for an off-road vehicle, such as an ATV or a UTV. For the purposes of this disclosure, a removable roof is a roof that may be installed or removed with only the common hand tools used for off-road vehicle maintenance, and without the need for cutting structures that are normally intended to be permanent.

The vehicle roof may be attached or attachable to an off-road vehicle. When that is the case, the assembly may comprise a tubular frame (such as a roll cage) mounted to a vehicle body, and the polycarbonate sheet mounted to the cage. The solar energy collection panels/elements are mounted to or encapsulated in the polycarbonate sheet.

and including a forward frame member, a pair of sideward frame members extending perpendicularly from the forward frame member and parallel to each other, and a rearward frame member extending perpendicularly from each of sideward frame members and parallel to the forward frame member, thus defining and providing a roof area; and a vehicle roof removably mounted to the tubular frame. As before, the roof may comprise a sheet of clear polycarbonate, having a top surface and a bottom surface; one or more solar energy collection elements fixedly attached to the sheet of polycarbonate; and an electrical connection adapted to allow energy collected by the solar energy collection elements to flow to an electrical power output.

In another aspect of the present invention, there is provided a kit for providing a removable solar roof to an off-road ATV or UTV. The kit may comprise an A-pillar, a B-pillar, and an optional C-pillar. Horizontal cross members span the distance between the right- and left-hand side pillars, and longitudinal members connect the pillars, front to rear. The cage may also include surfaces for accepting bolts or other fasteners.

It is to be appreciated that in one aspect of the present invention the roof may be removably attachable to the cage of an off-road vehicle using fasteners that may be installed or removed using only common hand tools. For example, the roof may be installed and/or removed using clamps or clips that are attached using threaded fasteners such as nuts and bolts, so that normal hand tools are all that is required to install or remove the roof in the field.

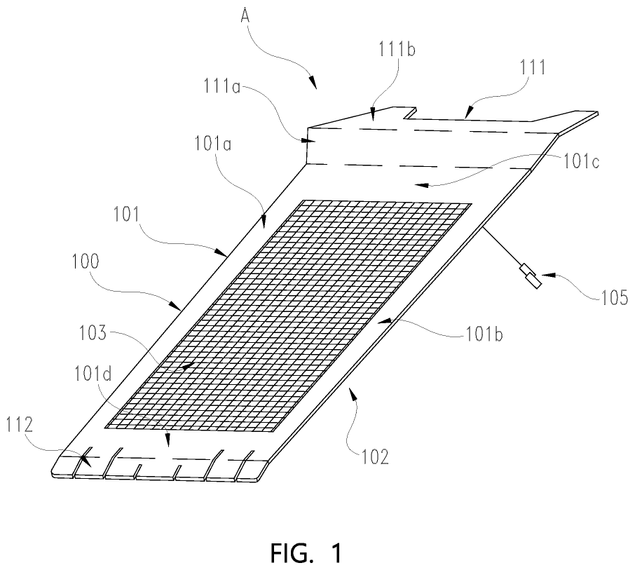

Referring now to the drawings, FIG. 1 shows a top perspective view of one embodiment of the present invention. The illustrated vehicle roof assembly A comprises a sheet of polycarbonate 100, having a top surface 101 and a bottom surface 102. An array 103 of solar energy collection elements is provided on the top surface of the clear polycarbonate sheet. Also provided is an electrical connection 105 adapted to allow energy collected by the solar energy collection elements to flow to an electrical power output.

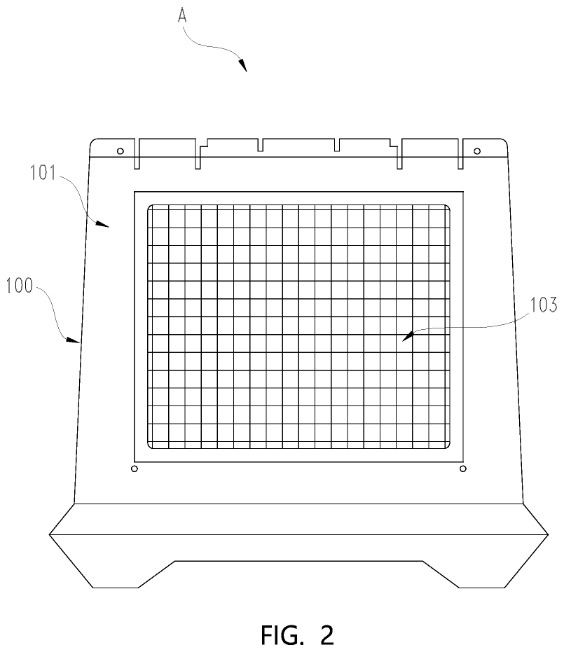

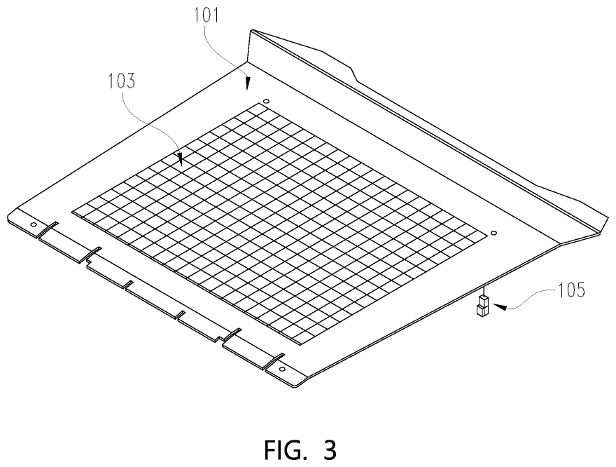

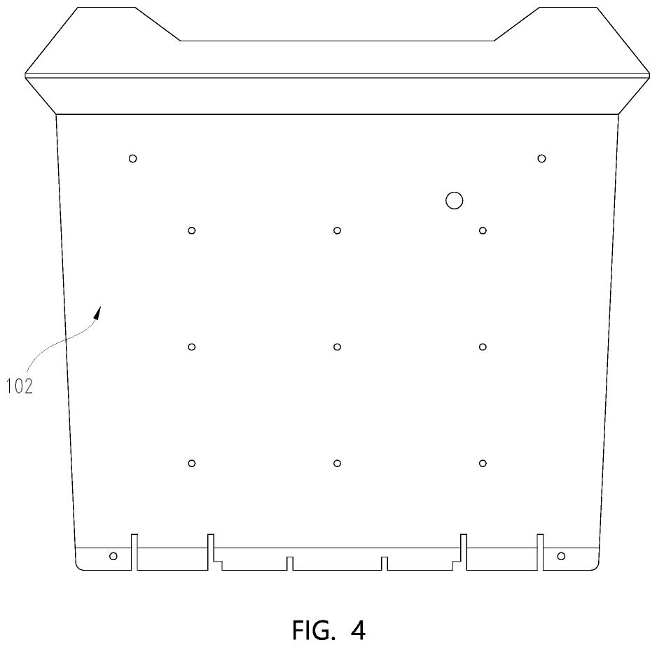

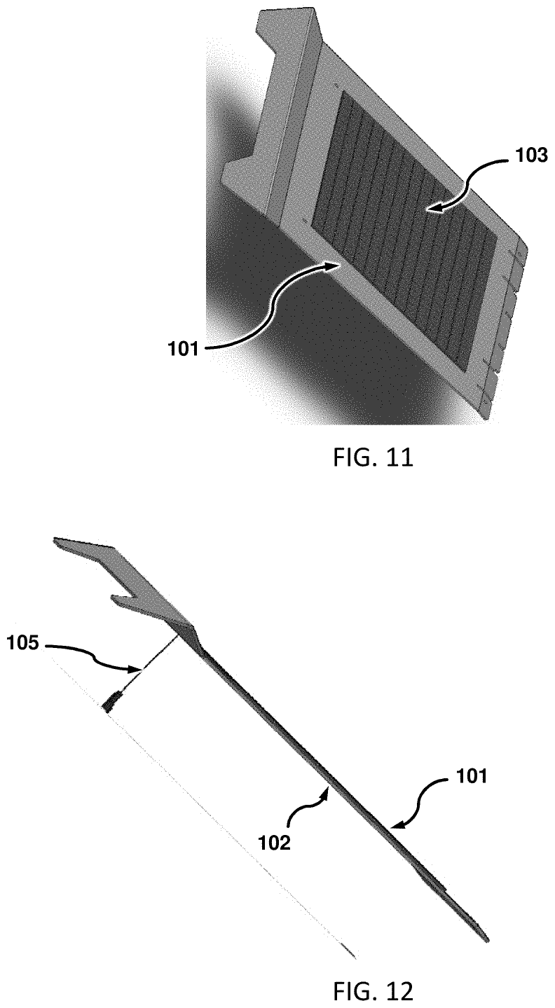

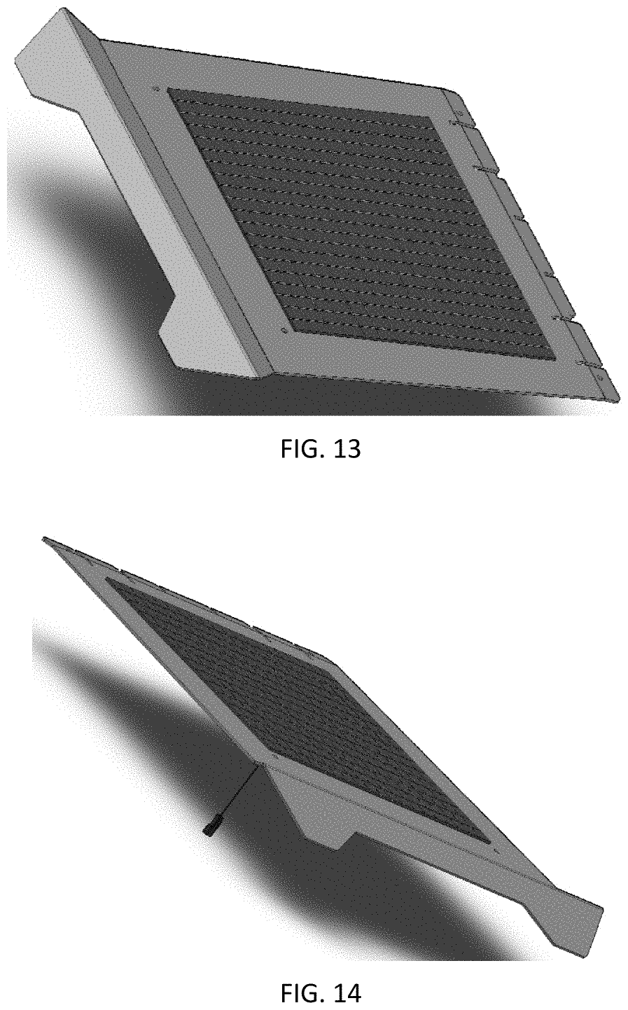

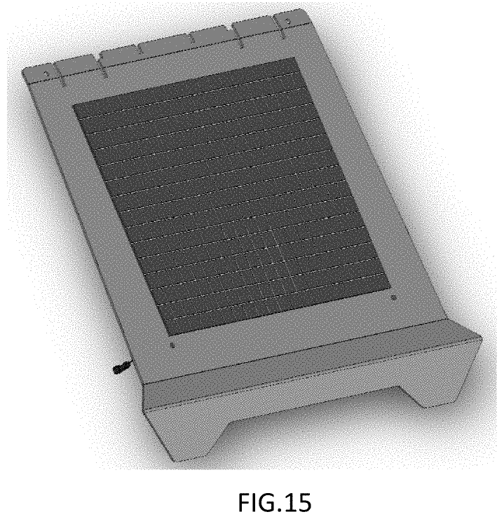

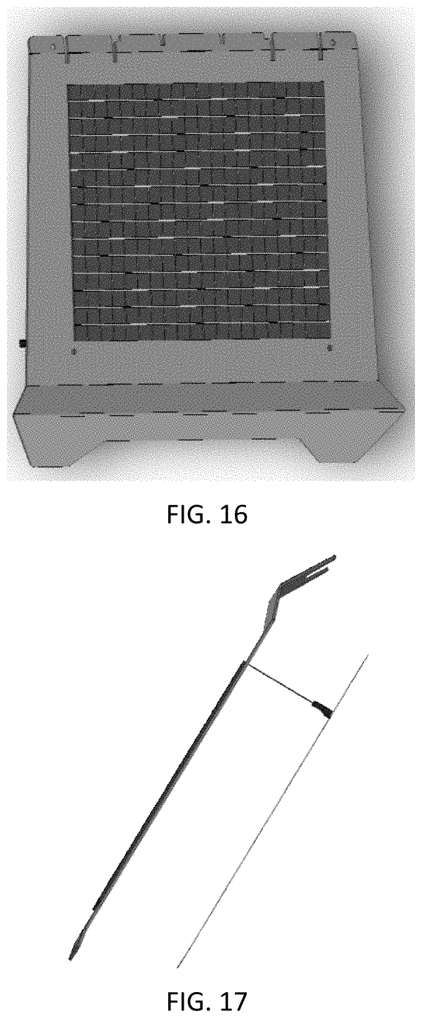

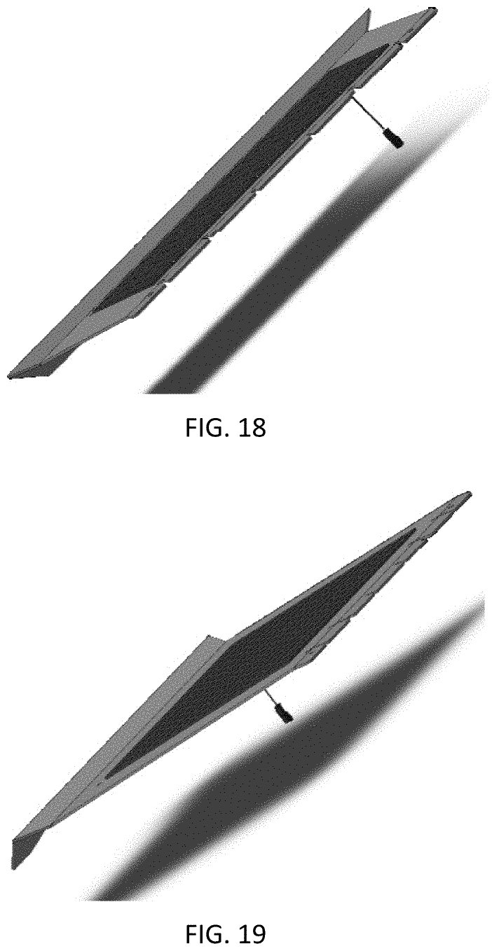

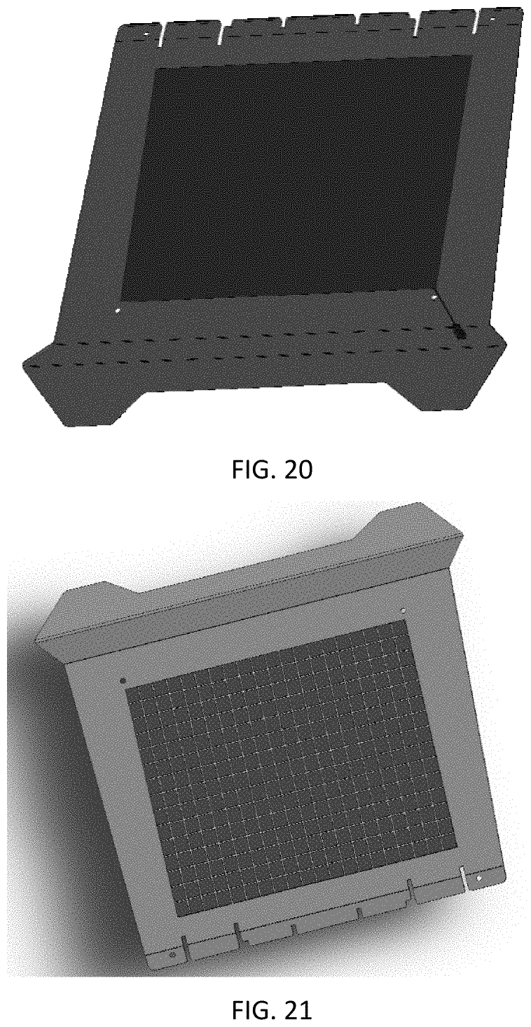

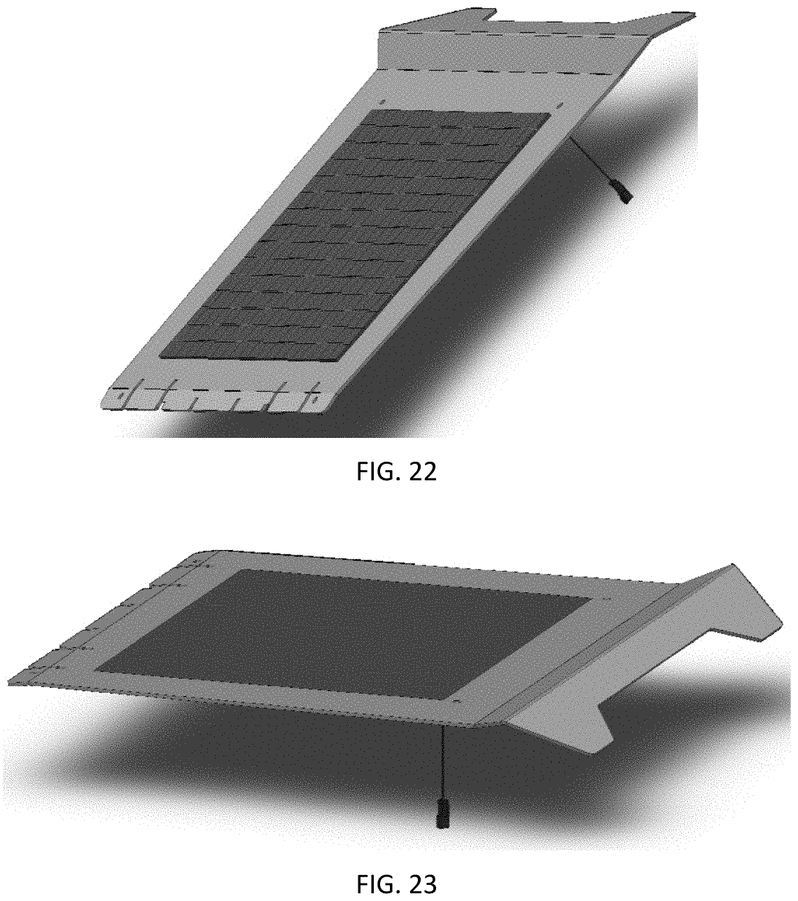

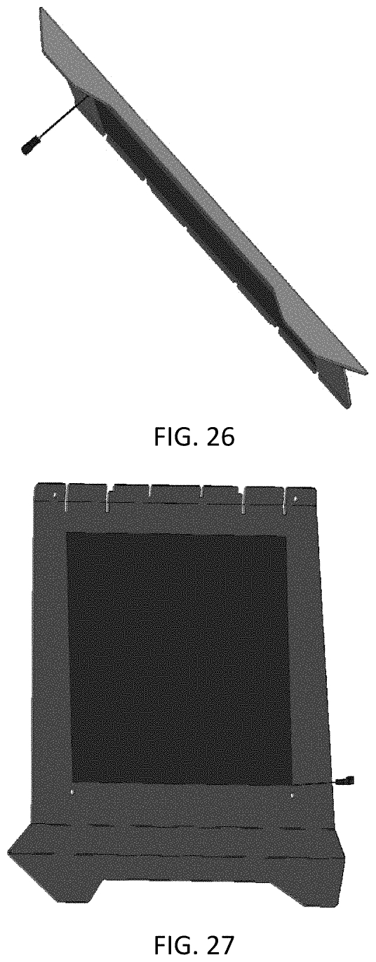

FIGS. 2-29 show other views and embodiments of the present invention. In particular, FIG. 2 shows a top plan view of one preferred embodiment, showing polycarbonate sheet 100 having a top surface 101 that supports solar energy collection elements 103. FIG. 3 shows a top perspective view of the embodiment of FIG. 2, showing top surface 101 supporting solar energy collection elements 103 that are connected to the vehicle by electrical connection 105. FIG. 4 shows a bottom plan view of the embodiment of FIG. 2, showing bottom surface 102 of polycarbonate sheet 100.

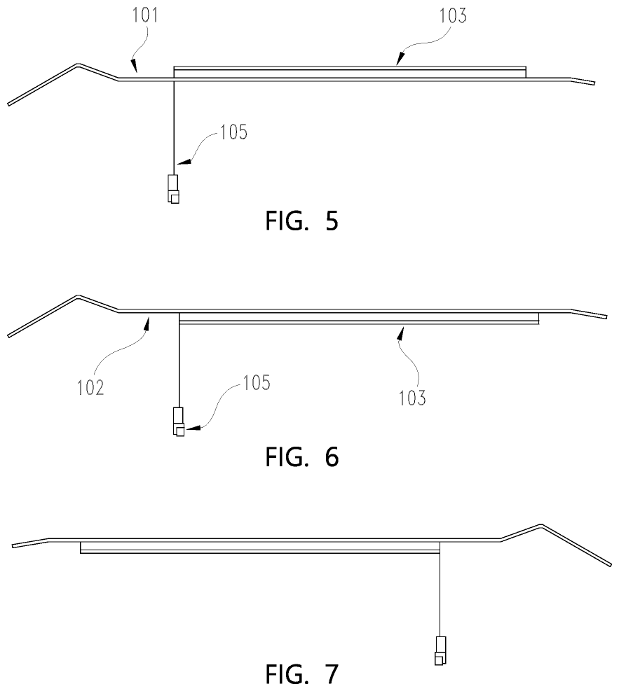

FIG. 5 shows a side elevational view of the embodiment of FIG. 2. Solar energy collection elements 103 are supported on top surface 101, and are connected to the vehicle by electrical connection 105.

FIG. 6 shows a side elevational view of another embodiment of the present invention. Solar energy collection elements 103 are supported on bottom surface 102, and are connected to the vehicle by electrical connection 105. FIG. 7 shows an opposite side elevational view of the embodiment of FIG. 6.

Note that in both the embodiment of FIG. 1 and the embodiment of FIG. 6, as well as in other embodiments, the plurality of solar energy collection elements may be fixedly attached to the sheet of polycarbonate, or the plurality of solar energy collection elements may be removably attached to the polycarbonate.

Similarly, in both the embodiment of FIG. 1 and the embodiment of FIG. 6, as well as in other embodiments, the plurality of solar energy collection elements may be attached directly to the surface of the sheet of polycarbonate, or the plurality of solar energy collection elements may be attached indirectly to the surface of the sheet of polycarbonate.

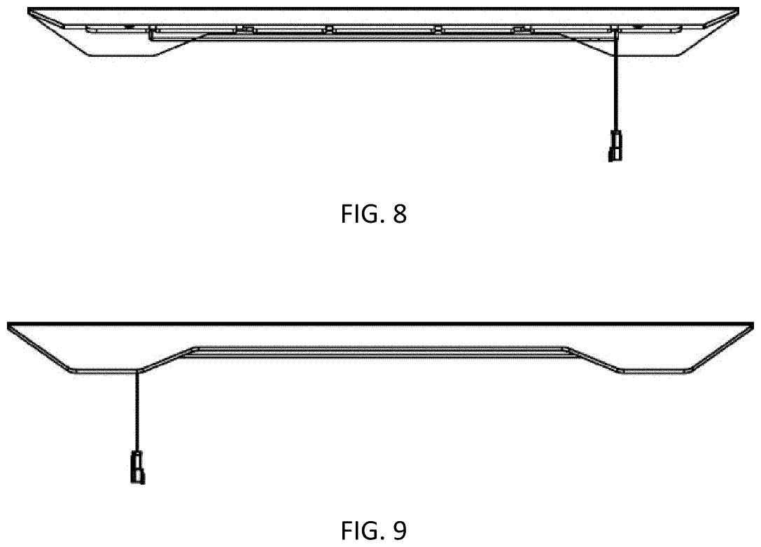

FIGS. 8 and 9 show front and rear elevational views of the embodiment of FIG. 2.

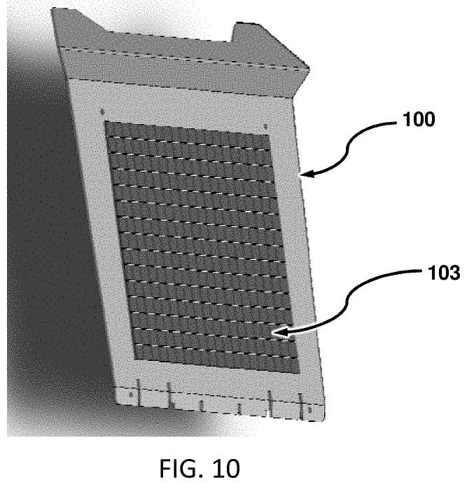

FIGS. 10-23 show other views of the embodiment of FIG. 1.

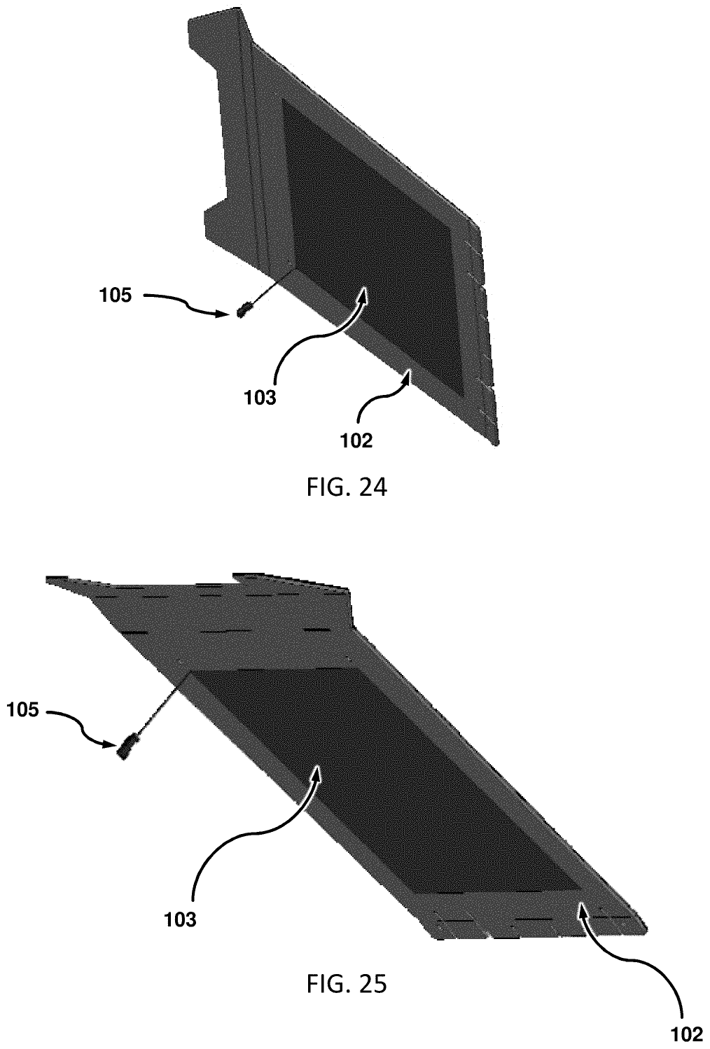

FIGS. 24-29 show other views of the embodiment of FIG. 6.

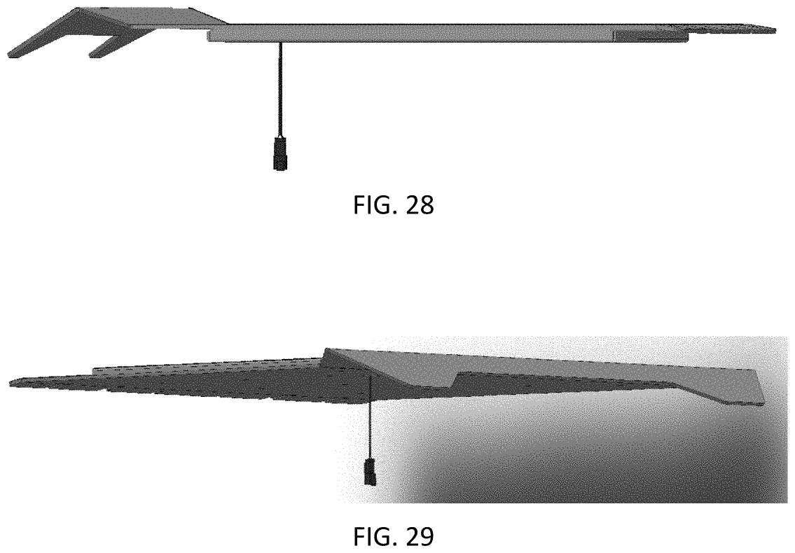

FIGS. 28 and 29 show views of an embodiment in which solar energy collection elements 103 are supported on both top surface 101 and bottom surface 102.

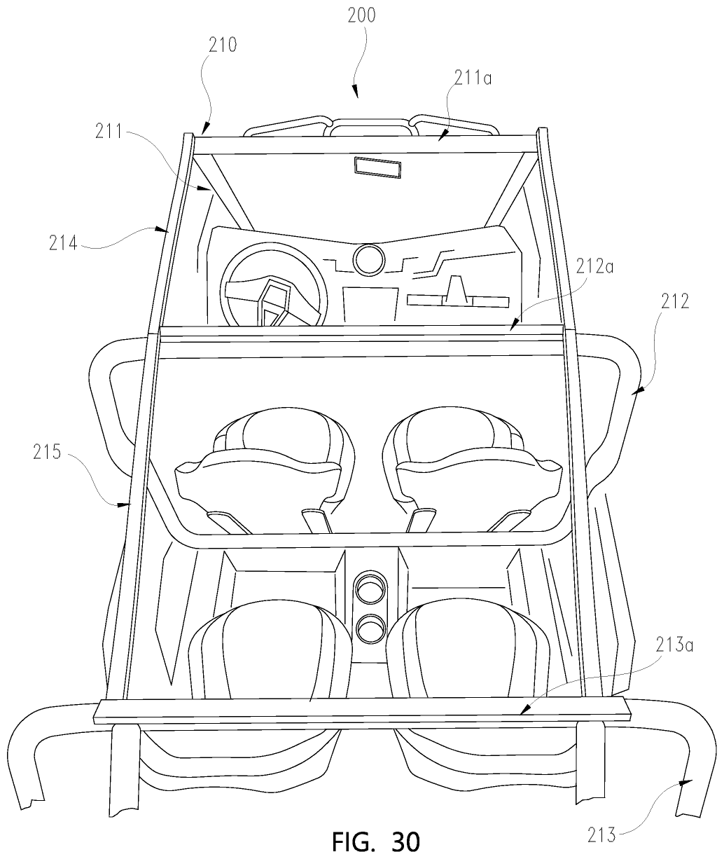

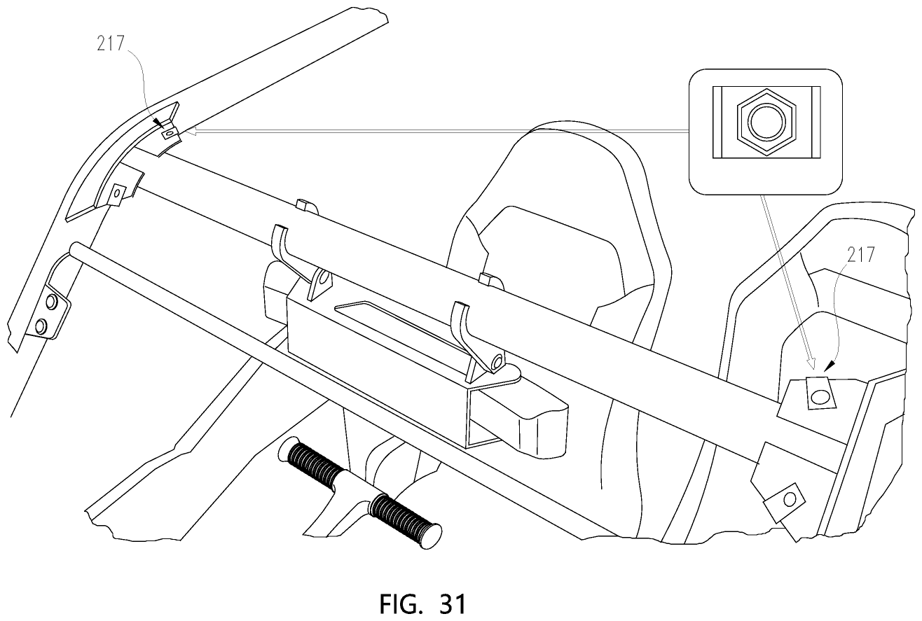

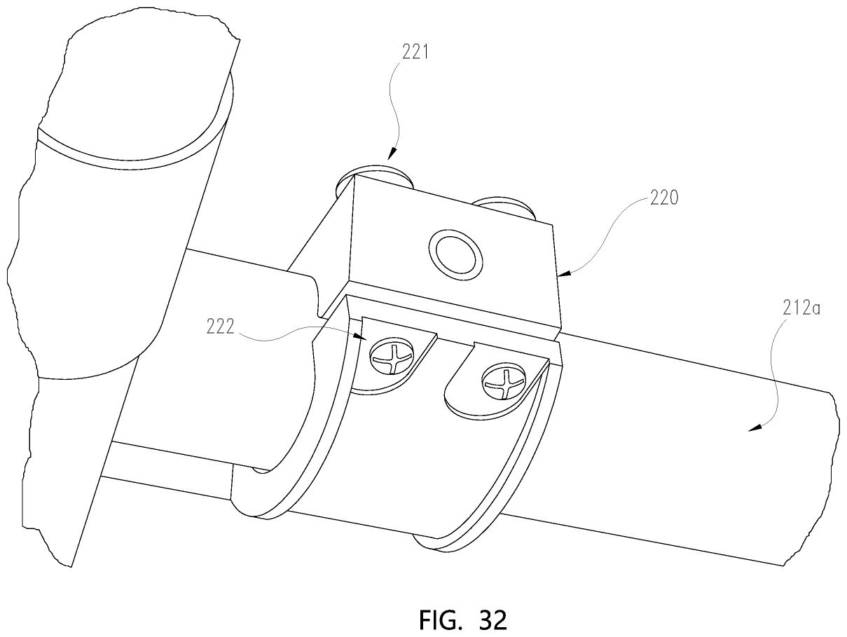

FIGS. 30-34 show the attachment of the removable solar roof to an off-road vehicle. In FIG. 30, a vehicle 200 is shown with a roll-over protection system 210 (frequently called a cage) being provided thereon. The illustrated cage 210 includes an A-pillar 211, a B-pillar 212, and a C-pillar 213. Horizontal cross members 211a, 212a, and 213a, span the distance between the right- and left-hand side pillars. Longitudinal members 214 connect the pillars, front to rear. The cage may also include surfaces 217 for accepting bolts or other fasteners, as illustrated in FIG. 31.

FIG. 32 shows clamps 220 that may be used to attach the inventive roof to the vehicle. The clamps facilitate quick installation and/or removal for the roof from the vehicle, in contrast to solar roofs that are permanently attached to the vehicle.

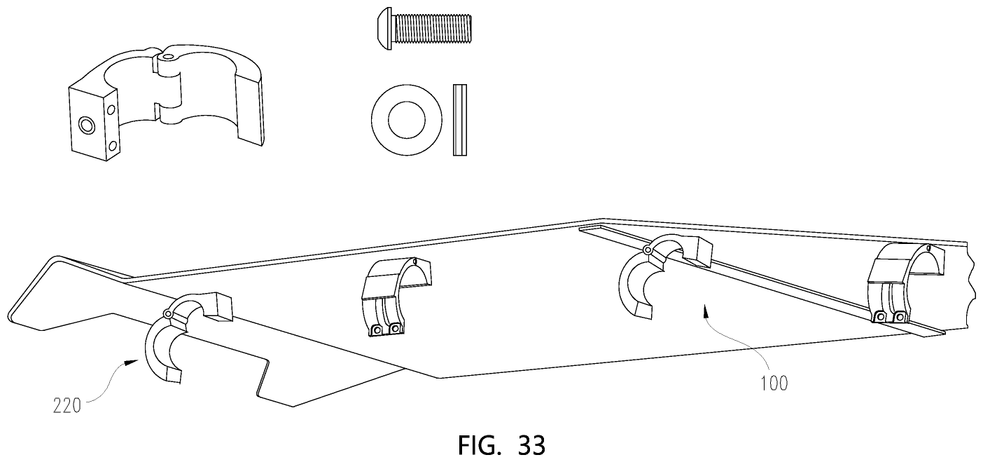

FIG. 33 shows clamps 220 attached to polycarbonate sheet 100.

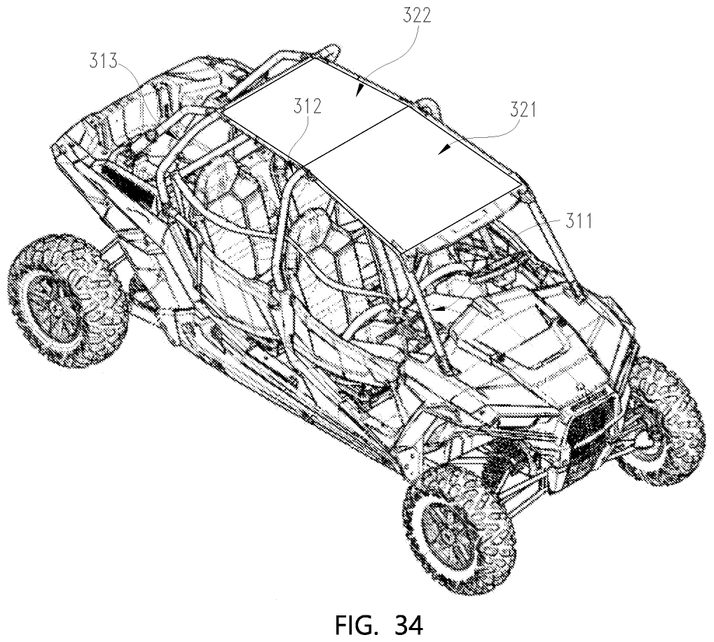

FIG. 34 shows an off-road vehicle with polycarbonate sheet 100 removably attached to a vehicle. Solar energy collection elements 103 are positioned on the bottom surface of the roof. This protects the solar energy collection elements and reduces drag. In the illustrated embodiment the roof assembly comprises a first sheet 321 of polycarbonate and a second sheet 322 of polycarbonate, either or both of which may support or encapsulate solar energy collection elements and the appropriate electrical connections.

In another aspect of the present invention there is provided an ornamental design for a vehicle roof. The ornamental design is shown in FIGS. 2-9.

1-12. (canceled)

13. A vehicle roof assembly, comprising:
a) an open, tubular roll-over protection system cage mounted to an off-road, all-terrain vehicle body, the cage comprising a pair of tubular A-pillar members, a pair of tubular B-pillar members, a first tubular cross member connecting the two A-pillar members, a second tubular cross member connecting the two B-pillar members, a first tubular longitudinal member connecting one of the A-pillar members to the corresponding B-pillar member, and a second tubular longitudinal member connecting the other of the A-pillar members to the other of the B-pillar members;
b) a solar roof assembly removably mountable to the open, tubular roll-over protection system cage, the solar roof assembly comprising:
i) a sheet of clear polycarbonate, having a top surface and a bottom surface;
ii) one or more solar energy collection elements encapsulated within, the sheet of polycarbonate; and
iii) an electrical connection adapted to allow energy collected by the solar energy collection elements to flow to an electrical power output; and
c) one or more fasteners effective for removably attaching the solar roof assembly directly to the open, tubular roll-over protection system cage, wherein one or more of said fasteners comprises a clamping member adapted to encircle a section of a tubular cage member.

14. (canceled)

15. A vehicle roof assembly according to claim 13 wherein one or more of the fasteners comprises clamps adapted to fasten the roof assembly directly to the roll-over protection system cage using threaded nuts or bolts.

16. (canceled)

17. A vehicle roof assembly according to claim 13 wherein the cage additionally comprises a pair of C-pillar members, a third tubular cross member connecting the two C-pillar members, a third longitudinal member connecting one of the B-pillar members to the corresponding C-pillar member, and a fourth longitudinal member connecting the other of the B-pillar members to the other of the C-pillar members.

18. A kit for providing a removable solar roof to an off-road vehicle equipped with an open, tubular roll-over protection system cage, the kit comprising:
a) a removable solar roof comprising a sheet of clear polycarbonate and having a top surface and a bottom surface;
b) one or more solar energy collection elements encapsulated within, the roof polycarbonate;
c) an electrical connection to allow electrical energy collected by the solar energy collection elements to flow to a solar power output; and
d) one or more fasteners for removably attaching the roof directly to the roll-over protection system cage using threaded nuts or bolts; wherein one or more of the fasteners comprises a clamping member adapted to encircle a section of a tubular cage member and effective for removably attaching the solar roof assembly directly to the open, tubular roll-over protection system cage.

19-20. (canceled)

21. A vehicle roof assembly adapted to removably mount to an open, tubular roll-over protection system cage of a utility task vehicle (UTV) or an all-terrain vehicle (ATV), the roll-over protection system cage comprising a pair of tubular A-pillar members, a pair of tubular B-pillar members, a first tubular cross member connecting the two A-pillar members, a second tubular cross member connected to the two B-pillar members, a first longitudinal tubular member connecting one of the A-pillar members to the corresponding B-pillar member, and a second longitudinal tubular member connecting the other of the A-pillar members to the other of the B-pillar members; the vehicle roof assembly comprising:
a) a sheet of clear polycarbonate, having a top surface and a bottom surface;
b) one or more solar energy collection elements attached to, or contained within, the sheet of polycarbonate;
c) an electrical connection adapted to allow energy collected by the solar energy collection elements to flow to an electrical power output; and
d) one or more fasteners effective for removably attaching the assembly directly to the open, tubular roll-over protection system cage; wherein said fasteners comprise a clamping member adapted to encircle a section of a tubular cage member and effective for removably attaching the solar roof assembly directly to the open, tubular roll-over protection system cage.

22. The vehicle roof assembly according to claim 21 wherein the one or more of the clamping members attaches the roof assembly directly to the roll-over protection system cage using threaded nuts or bolts.

23-24. (canceled)

25. A vehicle roof assembly, comprising:
a) an open, tubular roll-over protection system cage mounted to an off-road, all-terrain vehicle body, the cage comprising a pair of tubular A-pillar members, a pair of tubular B-pillar members, a first tubular cross member connecting the two A-pillar members, a second tubular cross member connecting the two B-pillar members, a first tubular longitudinal member connecting one of the A-pillar members to the corresponding B-pillar member, and a second tubular longitudinal member connecting the other of the A-pillar members to the other of the B-pillar members;
b) a solar roof assembly removably mountable to the open, tubular roll-over protection system cage, the solar roof assembly comprising:
i) a sheet of clear polycarbonate, having a top surface and a bottom surface;
ii) one or more solar energy collection elements attached to the bottom surface of the sheet of polycarbonate; and
iii) an electrical connection adapted to allow energy collected by the solar energy collection elements to flow to an electrical power output.

26. A vehicle roof assembly according to claim 25, and further comprising one or more fasteners effective for removably attaching the solar roof assembly directly to the open, tubular roll-over protection system cage, wherein one or more of said fasteners comprises a clamping member adapted to encircle a section of a tubular cage member.
